(19) United States
(12) Patent Application Publication
(10) Pub. No.: US 2025/0162357 A1
(43) Pub. Date: May 22, 2025

(54) CLAMP MECHANISM AND CARRYING VEHICLE

(71) Applicant: EXEDY Corporation, Osaka (JP)

(72) Inventor: Shin INOUE, Osaka (JP)

(21) Appl. No.: 18/924,147

(22) Filed: Oct. 23, 2024

(30) Foreign Application Priority Data
Nov. 22, 2023 (JP) 2023-198312

(51) Int. Cl. B60D 1/04

(52) U.S. Cl. CPC B60D 1/04

(57) ABSTRACT

The disclosed clamp mechanism includes a base portion, a first clamp portion, and a second clamp portion to reliably clamp an object by the clamp mechanism. The first clamp portion includes a first clamp surface. The first clamp portion is fixed to the base portion. The second clamp portion includes a second clamp surface. The second clamp surface is configured to clamp an object together with the first clamp surface therebetween in a first direction. The second clamp portion is attached to the base portion to be movable not only by rotation but also by parallel displacement along the first direction.

### CROSS-REFERENCE TO RELATED APPLICATIONS

This application is based on and claims the priority benefit of Japanese application 2023-198312 filed on Nov. 22, 2023, the contents of which are incorporated herein by reference.

### TECHNICAL FIELD

The claimed invention relates to a clamp mechanism and a carrying vehicle.

### BACKGROUND

A carrying vehicle (electric towing vehicle, automated guided vehicle (AGV), etc.) is configured to tow and carry a carried vehicle such as a cart as illustrated, for example, in Japan Laid-open Patent Application Publication No. 2018-108795. The carrying vehicle includes a joint mechanism to be joinable to a variety of carried vehicles.

A clamp mechanism, configured to clamp the carried vehicle for easily joining and detaching the carrying vehicle to and from the carried vehicle, can be exemplified as the joint mechanism described above.

### SUMMARY OF THE INVENTION

It would be desirable for the carrying vehicle to reliably clamp the carried vehicle by the clamp mechanism. It is an object of the claimed invention to provide a clamp mechanism by which an object can be reliably clamped.

A clamp mechanism according to a first aspect includes a base portion, a first clamp portion, and a second clamp portion. The first clamp portion includes a first clamp surface. The first clamp portion is fixed to the base portion. The second clamp portion includes a second clamp surface. The second clamp surface is configured to clamp an object together with the first clamp surface therebetween in a first direction. The second clamp portion is attached to the base portion to be movable not only by rotation but also by parallel displacement along the first direction.

When the second clamp portion is moved only by parallel displacement (also called translation) so as to clamp the object, it is concerned that the second clamp portion is moved in the first direction, while in contact with the object. When the second clamp portion is thus moved in the first direction, while in contact with the object, it is concerned that the second clamp portion is engaged by friction with the object and is thereby made immovable in the first direction; namely, the object cannot be reliably clamped. By contrast, in the clamp mechanism according to the first aspect, the second clamp portion is not moved only by parallel displacement but is moved by both parallel displacement and rotation such that the object can be clamped. Because of this, the second clamp portion can be prevented from moving in the first direction, while in contact with the object. As a result, the object can be reliably clamped by the clamp mechanism.

A clamp mechanism according to a second aspect relates to the clamp mechanism according to the first aspect and is configured as follows. One of the second clamp portion and the base portion includes a first groove and a second groove. The first groove extends straight along the first direction. The second groove extends in a circular-arc shape. The other of the second clamp portion and the base portion includes a first protrusion and a second protrusion. The first protrusion is engaged with the first groove. The second protrusion is engaged with the second groove.

A clamp mechanism according to a third aspect relates to the clamp mechanism according to the first or second aspect and is configured as follows. The first clamp portion includes a third clamp surface. The second clamp portion includes a fourth clamp portion. The fourth clamp portion is configured to clamp the object together with the third clamp surface therebetween in a second direction. The second direction is oriented orthogonal to the first direction. The second clamp portion is attached to the base portion to be movable by parallel displacement along the second direction.

A clamp mechanism according to a fourth aspect relates to the clamp mechanism according to the third aspect and is configured as follows. One of the second clamp portion and the base portion includes a first groove and a second groove. The first groove extends straight not only along the first direction but also along the second direction. The second groove extends in a circular-arc shape. The other of the second clamp portion and the base portion includes a first protrusion and a second protrusion. The first protrusion is engaged with the first groove. The second protrusion is engaged with the second groove.

A carrying vehicle according to a fifth aspect includes a carrying vehicle body and the clamp mechanism recited in any of the first to fourth aspects. The carrying vehicle body includes a prime mover and a drive wheel. The clamp mechanism is attached to the carrying vehicle body.

Overall, according to the claimed invention, the object can be reliably clamped by the clamp mechanism.

### BRIEF DESCRIPTION OF THE DRAWINGS

FIG. 1 is a side view of a carrying vehicle in accordance with the claimed invention.

FIG. 2 is a side view of the carrying vehicle shown in FIG. 1, from which a frame is detached in part.

FIG. 3 is an enlarged perspective view of a portion of the carrying vehicle.

FIG. 4 is an enlarged side view of a clamp mechanism of the carrying vehicle, partially in section, in a configuration in which an object has not been clamped.

FIG. 5 is an enlarged side view of the clamp mechanism, partially in section, in a configuration in which the object has been clamped.

### DETAILED DESCRIPTION

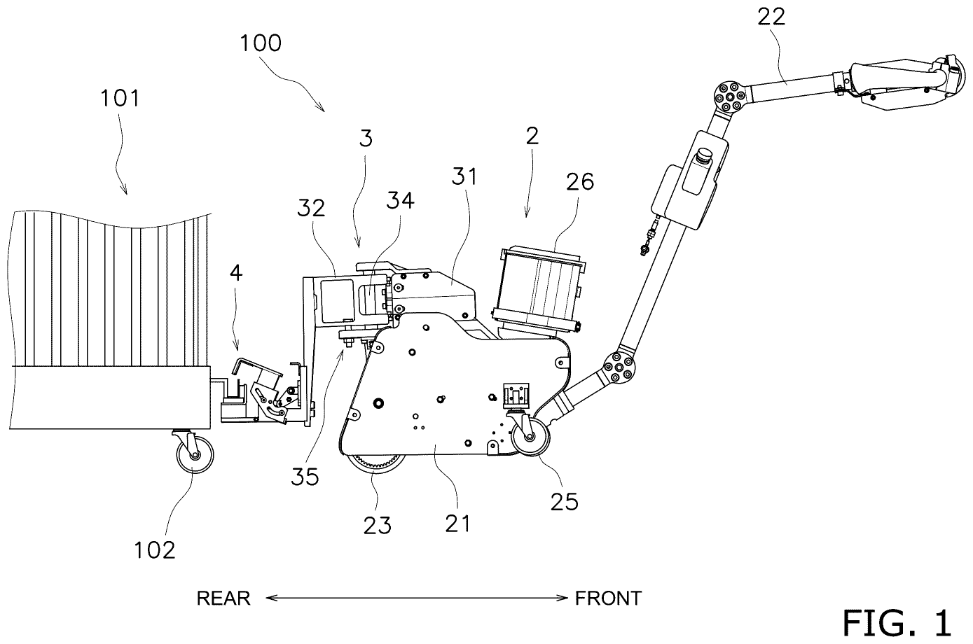

A clamp mechanism 4 according to a presently preferred embodiment, and a carrying vehicle 100 in which the same is installed, will be explained with reference to the drawings. It should be noted that in the following explanation, the term “front” refers to a direction that the carrying vehicle 100 is moved while towing a carried vehicle 101, whereas the term “rear” refers to a direction that the carrying vehicle 100 is moved while pushing the carried vehicle 101. In other words, the right side in FIG. 1 corresponds to the front side, whereas the left side in FIG. 1 corresponds to the rear side.

### <Carrying Vehicle>

FIG. 1 is a side view of the carrying vehicle 100. It should be noted that FIG. 1 shows the carrying vehicle 100 that has not been joined to the carried vehicle 101. As shown in FIG. 1, the carrying vehicle 100 is configured to be joined to the carried vehicle 101 to tow the carried vehicle 101. The carrying vehicle 100 is driven by a human drive force and an assist force generated by a prime mover 24. It should be noted that the carrying vehicle 100 is capable of traveling by either the human drive force or the drive force generated by the prime mover 24 alone. It should be noted that in a presently preferred embodiment, a cage cart is exemplified as the carried vehicle 101; however, a variety of vehicles other than the cage cart (cart, stretcher, wheelchair, etc.) can be exemplified as the carried vehicle 101.

The carrying vehicle 100 includes a carrying vehicle body 2, a pivot mechanism 3, and a clamp mechanism 4. The carried vehicle 101, carried by the carrying vehicle 100, includes a plurality of wheels 102.

### <Carrying Vehicle Body>

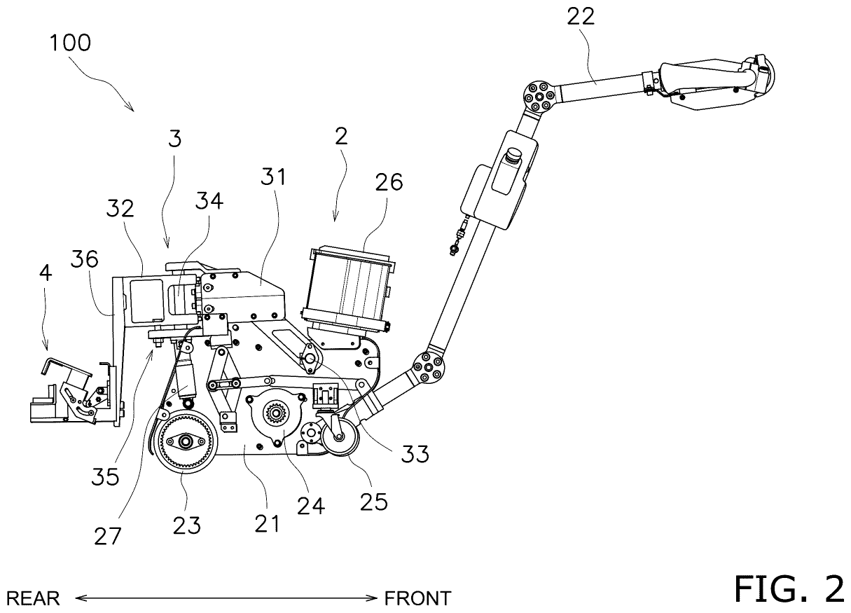

FIG. 2 is a side view of the carrying vehicle 100, from which the frame 21 of the carrying vehicle body 2 shown in FIG. 1 is detached in part. As shown in FIGS. 1 and 2, the carrying vehicle body 2 includes the frame 21, an operating member 22, a drive wheel 23, the prime mover 24, a driven wheel 25, a battery 26, and an urging member 27.

The operating member 22 is attached to the frame 21. The operating member 22 is configured to receive the human drive force forwardly or rearwardly inputted thereto by a user. For example, a handle to be held by the user is attached to the distal end of the operating member 22.

The drive wheel 23, the prime mover 24, the driven wheel 25, the battery 26, and the urging member 27 are attached to the frame 21. The drive wheel 23 is driven by the prime mover 24. The prime mover 24 may, for instance, be an electric motor. The prime mover 24 is supplied with electricity from the battery 26.

The urging member 27 is configured to urge the drive wheel 23 downward. The urging member 27 is disposed between the pivot mechanism 3 (specifically, a first pivot portion 31 thereof) and the drive wheel 23. The urging member 27 urges the pivot mechanism 3 and the drive wheel 23 away from each other. The urging member 27 is attached at the upper end thereof to the pivot mechanism 3, while being attached at the lower end thereof to the frame 21. The urging member 27 urges the drive wheel 23 downward through the frame 21. The urging member 27 may, for instance, be a coil spring. The urging member 27 is installed such that it is compressed when the carried vehicle 101 is joined to the carrying vehicle 100.

### <Pivot Mechanism>

The pivot mechanism 3 is attached to an upper part of the carrying vehicle body 2. The pivot mechanism 3 is attached to the carrying vehicle body 2 to be pivotable in both an up-and-down direction and a horizontal direction. The pivot mechanism 3 includes the first pivot portion 31 and a second pivot portion 32.

The first pivot portion 31 is attached to the carrying vehicle body 2 to be pivotable in the up-and-down direction. Specifically, the first pivot portion 31 is pivotable in the up-and-down direction along a vertical plane extending in a back-and-forth direction. The first pivot portion 31 is attached to the frame 21 through a first pivot shaft 33. The first pivot shaft 33 extends in a right-and-left direction. Additionally, the first pivot portion 31 is attached to the frame 21 through the urging member 27, etc.

The second pivot portion 32 is disposed behind the first pivot portion 31. The second pivot portion 32 is attached to the first pivot portion 31 to be pivotable in the horizontal direction. Specifically, the second pivot portion 32 is attached to the first pivot portion 31 to be pivotable in the right-and-left direction. The second pivot portion 32 is attached to the first pivot portion 31 through a second pivot shaft 34. The second pivot shaft 34 extends in the up-and-down direction.

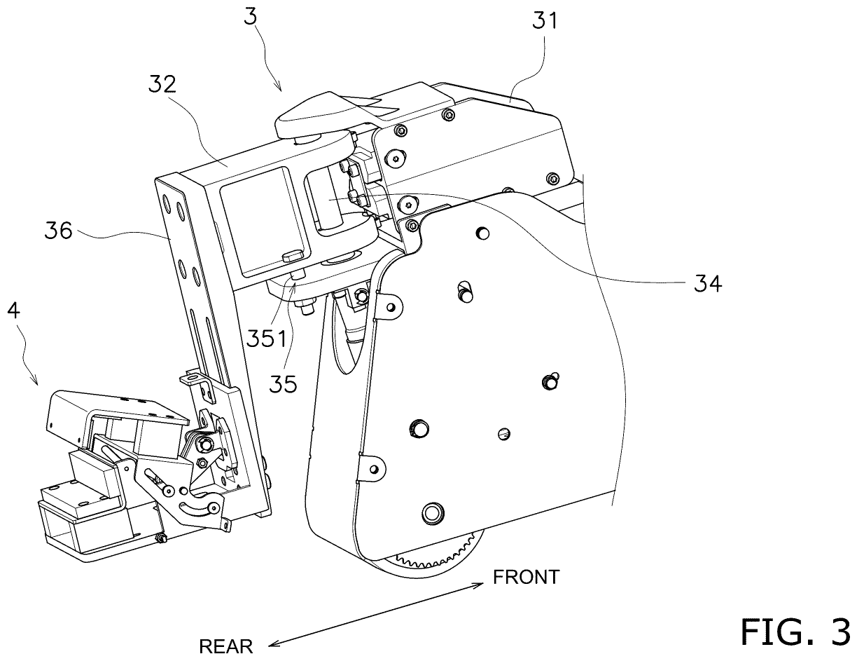

FIG. 3 is an enlarged perspective view of the carrying vehicle 100. As shown in FIG. 3, the pivot mechanism 3 includes a lock mechanism 35 and an arm 36. The lock mechanism 35 is configured to lock the second pivot portion 32 from pivoting in the horizontal direction, albeit capable of unlocking the pivot of the second pivot portion 32. The lock mechanism 35 includes a lock pin 351. The lock pin 351 penetrates the first pivot portion 31 and the second pivot portion 32. The lock pin 351 extends in the up-and-down direction. For example, a bolt is usable as the lock pin 351. In the lock mechanism 35, the pivot of the second pivot portion 32 is unlocked by detaching the lock pin 351.

For example, when all the wheels 102 of the carried vehicle 101 are of a multidirectional type, the lock mechanism 35 is turned to a locked state. Accordingly, the second pivot portion 32 is made non-pivotable with respect to the first pivot portion 31. By contrast, when the wheels 102 of the carried vehicle 101 include wheels of both multidirectional and unidirectional types, the lock mechanism 35 is turned to an unlocked state. Accordingly, the second pivot portion 32 is made pivotable with respect to the first pivot portion 31.

The arm 36 extends downward from the second pivot portion 32. The arm 36 is fixed to the second pivot portion 32. In other words, the arm 36 is unitarily pivoted with the second pivot portion 32. The arm 36 may be fixed to the second pivot portion 32 by bolts, etc. The arm 36 is provided as a member separated from the second pivot portion 32; however, the arm 36 may be integrated with the second pivot portion 32 as a single member.

### <Clamp Mechanism>

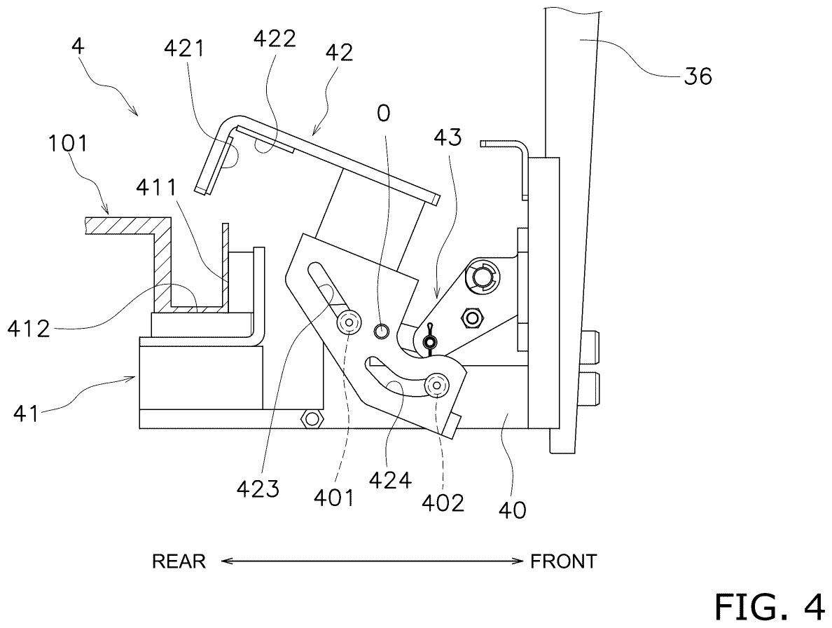

FIG. 4 is an enlarged side view of the clamp mechanism 4 shown in detail. FIG. 4 shows the clamp mechanism 4, by which an object has not been clamped. As shown in FIG. 4, the clamp mechanism 4 is attached to the carrying vehicle body 2. When described in detail, the clamp mechanism 4 is attached to the carrying vehicle body 2 through the pivot mechanism 3.

The clamp mechanism 4 is attached to the distal end (e.g. the lower end) of the arm 36. The clamp mechanism 4 is configured to be movable with respect to the arm 36 in the up-and-down direction. For example, the clamp mechanism 4 may be fixed to the arm 36 by a plurality of bolts, etc., and is made movable with respect to the arm 36 in the up-and-down direction by loosening the bolts.

The clamp mechanism 4 is configured to clamp the carried vehicle 101. The clamp mechanism 4 clamps an outer peripheral part of the carried vehicle 101. The clamp mechanism 4 includes a base portion 40, a first clamp portion 41, and a second clamp portion 42.

The base portion 40 is attached to the arm 36. While it is attached to the arm 36, the base portion 40 is not moved with respect to the arm 36. The base portion 40 includes a pair of first protrusions 401 and a pair of second protrusions 402. The pair of first protrusions 401 and the pair of second protrusions 402 protrude outward in the right-and-left direction. The base portion 40 is provided with one protrusion 401 and one second protrusion 402 on the right sidewall thereof, while being provided with the other first protrusion 401 and the other second protrusion 402 on the left sidewall thereof.

The first clamp portion 41 is fixed to the base portion 40. The first clamp portion 41 includes a first clamp surface 411 and a third clamp surface 412. The first clamp surface 411 faces rearward. The third clamp surface 412 faces upward. The third clamp surface 412 extends rearward from the lower end of the first clamp surface 411. As viewed laterally, the first and third clamp surfaces 411 and 412 are combined in an L-shape.

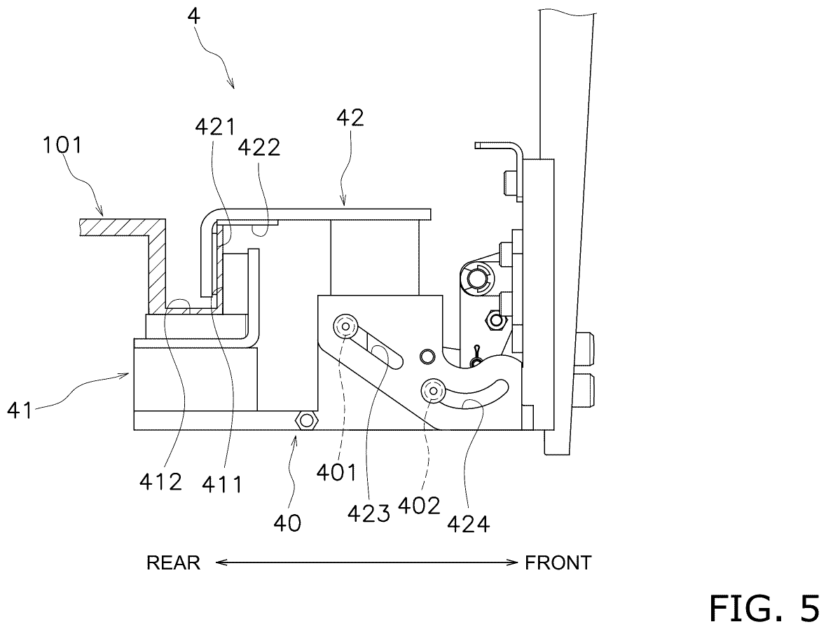

The second clamp portion 42 includes a second clamp surface 421 and a fourth clamp surface 422. FIG. 5 is an enlarged side view of the clamp mechanism 4 shown in detail. FIG. 5 shows the clamp mechanism 4, by which the object is being clamped. As shown in FIG. 5, the second clamp surface 421 is configured to face forward while the object is being clamped.

The second clamp surface 421 is configured to clamp the object (the carried vehicle 101 in part) together with the first clamp surface 411 therebetween. The first and second clamp surfaces 411 and 421 are configured to clamp the object in the back-and-forth direction (exemplary first direction).

While the object is being clamped, the fourth clamp surface 422 is configured to face downward. The fourth clamp surface 422 extends forward from the upper end of the second clamp surface 421. As viewed laterally, the second and fourth clamp surfaces 421 and 422 are combined in an L-shape. The fourth clamp surface 422 is configured to clamp the object together with the third clamp surface 412 therebetween. The third and fourth clamp surfaces 412 and 422 are configured to clamp the object in the up-and-down direction (exemplary second direction). In other words, the clamp mechanism 4 is configured to clamp the object in two directions composed of the back-and-forth direction and the up-and-down direction. The back-and-forth direction and the up-and-down direction are oriented orthogonal to each other.

As shown in FIGS. 4 and 5, the second clamp portion 42 is attached to the base portion 40, while being movable by parallel displacement (also called translation) along the back-and-forth direction and the up-and-down direction. Additionally, the second clamp portion 42 is attached to the base portion 40, while being movable by rotation.

The second clamp portion 42 includes a pair of first grooves 423 and a pair of second grooves 424. The second clamp portion 42 is provided with one first groove 423 and one second groove 424 on the right sidewall thereof, while being provided with the other first groove 423 and the other second groove 424 on the left sidewall thereof.

Each first groove 423 has a straight shape. Each first groove 423 extends along the back-and-forth direction and the up-and-down direction. In other words, each first groove 423 obliquely extends in the intermediate direction between the back-and-forth direction and the up-and-down direction. The pair of first protrusions 401 is disposed in and engaged with the pair of first grooves 423. Accordingly, the second clamp portion 42 is made movable by parallel displacement in the back-and-forth direction and is simultaneously made movable in the up-and-down direction as well.

Each second groove 424 extends in a circular-arc shape. Each second groove 424 is curved to bulge downward. In other words, the center of an imaginary circle formed in part by the circular-arc shape of each second groove 424 is located above each second groove 424. The pair of second protrusions 402 is disposed in and engaged with the pair of second grooves 424. Accordingly, the second clamp portion 42 is made to move by rotation. It should be noted that an end portion facing the opposite side of a clamp direction in each second groove 424, i.e., the rear-side end (left end in FIG. 4) has a straight shape.

The clamp mechanism 4 includes an operating portion 43. The operating portion 43 is configured to pull the second clamp portion 42 in the clamp direction and push the second clamp portion 42 to the opposite side of the clamp direction. The operating portion 43 is pivotably attached to the base portion 40. Besides, the operating portion 43 is rotatably attached to the second clamp portion 42. It should be noted that a rotational axis O for both the operating portion 43 and the second clamp portion 42 does not overlap with the center of the circular-arc shape of each second groove 424 in the direction that the second clamp portion 42 is pulled by the operating portion 43. Specifically, the rotational axis O for both the operating portion 43 and the second clamp portion 42 is disposed below the center of the imaginary circle formed in part by the circular-arc shape of each second groove 424.

A user operates the operating portion 43 via a lever and so forth (not specifically illustrated) installed in the vicinity of the handle of the operating member 22. As a result, the clamp mechanism 4 is enabled to clamp and unclamp the object.

For example, the second clamp portion 42 is urged rearward by an urging member such as a spring and/or so forth. In other words, a state of the clamp mechanism 4 shown in FIG. 4 corresponds to the initial state thereof. When the lever is operated, the operating portion 43 pulls the second clamp portion 42 forward, whereby the clamp mechanism 4 clamps the object as shown in FIG. 5. Conversely, when operation of the lever is released, the second clamp portion 42 is moved rearward by the urging member such as the spring and/or so forth, whereby the clamp mechanism 4 is restored to the initial state.

It should be noted that the second clamp portion 42 may be urged forward by an urging member such as a spring, etc. In this case, a state of the clamp mechanism 4 shown in FIG. 5 corresponds to the initial state thereof. When the lever is operated, the operating portion 43 pushes the second clamp portion 42 rearward, whereby the clamp mechanism 4 unclamps the object as shown in FIG. 4. Conversely, when the operation of the lever is released, the second clamp portion 42 is moved forward by the urging member such as the spring, etc., whereby the clamp mechanism 4 clamps the object.

As shown in FIG. 4, in the clamp mechanism 4, at which the object has not been clamped, the second clamp portion 42 is disposed above and in front of the first clamp portion 41.

When the second clamp portion 42 is pulled by the operating portion 43 in the clamp direction from this state, the second clamp portion 42 is moved forward and downward by parallel displacement, while being moved by counterclockwise rotation. Accordingly, the second and fourth clamp surfaces 421 and 422 can be prevented from coming into contact with the object until immediately before the object is clamped. Finally, as shown in FIG. 5, the object is clamped by the first and second clamp surfaces 411 and 421 in the back-and-forth direction, while being clamped by the third and fourth clamp surfaces 412 and 422 in the up-and-down direction.

### Modifications

One preferred embodiment of the claimed invention has been described above. However, the claimed invention is not limited to the above, and a variety of changes can be made without departing from the scope of the claimed invention. It should be noted that, basically speaking, respective modifications to be described are applicable simultaneously.

(a) In the preferred embodiment described above, the second clamp portion 42 is provided with the first grooves 423 and the second grooves 424, whereas the base portion 40 is provided with the first protrusions 401 and the second protrusions 402; however, the clamp mechanism 4 is not limited in configuration to this. For example, the base portion 40 may be provided with the first grooves 423 and the second grooves 424, whereas the second clamp portion 42 may be provided with the first protrusions 401 and the second protrusions 402.

(b) In the preferred embodiment described above, the first clamp portion 41 includes the first and third clamp surfaces 411 and 412; however, the first clamp portion 41 is not limited in configuration to this. For example, the first clamp portion 41 may include only the first clamp surface 411 without including the third clamp surface 412. In this case, the second clamp portion 42 includes only the second clamp surface 421 without including the fourth clamp surface 422.

(c) In the preferred embodiment described above, the object is clamped by the first and second clamp surfaces 411 and 421 in the back-and-forth direction; however, the object may be clamped by the first and second clamp surfaces 411 and 421 in any suitable direction other than the back-and-forth direction. For example, the object may be clamped by the first and second clamp surfaces 411 and 421 in the up-and-down direction, or alternatively, in the right-and-left direction.

(d) In the preferred embodiment described above, each first groove 423 extends not only in the back-and-forth direction but also in the up-and-down direction; however, each first groove 423 may extend in either the back-and-forth direction or the up-and-down direction alone. Specifically, when the object is clamped by the clamp mechanism 4 only in the back-and-forth direction, each first groove 423 may extend only in the back-and-forth direction. On the other hand, when the object is clamped by the clamp mechanism 4 only in the up-and-down direction, each first groove 423 may extend only in the up-and-down direction.

### LIST OF REFERENCE NUMERALS

2: Carrying vehicle body, 23: Drive wheel, 24: Prime mover, 4: Clamp mechanism, 40: Base portion, 401: First protrusion, 402: Second protrusion, 41: First clamp portion, 411: First clamp surface, 412: Third clamp surface, 42: Second clamp portion, 421: Second clamp surface, 422: Fourth clamp surface, 423: First groove, 424: Second groove, 100: Carrying vehicle

1. A clamp mechanism comprising:
a base portion;
a first clamp portion including a first clamp surface, the first clamp portion fixed to the base portion; and
a second clamp portion including a second clamp surface configured to clamp an object together with the first clamp surface therebetween in a first direction, the second clamp portion being attached to the base portion to be movable by rotation as well as by parallel displacement along the first direction.

2. The clamp mechanism according to claim 1, wherein one of the second clamp portion and the base portion includes a first groove and a second groove, the first groove extending straight along the first direction, the second groove extending in a circular-arc shape, and
the other of the second clamp portion and the base portion includes a first protrusion and a second protrusion, the first protrusion engaged with the first groove, the second protrusion engaged with the second groove.

3. The clamp mechanism according to claim 1, wherein
the first clamp portion includes a third clamp surface, the second clamp portion includes a fourth clamp portion configured to clamp the object together with the third clamp surface therebetween in a second direction oriented orthogonal to the first direction, and
the second clamp portion is attached to the base portion to be movable by parallel displacement along the second direction.

4. The clamp mechanism according to claim 3, wherein
one of the second clamp portion and the base portion includes a first groove and a second groove, the first groove extending straight not only along the first direction but also along the second direction, the second groove extending in a circular-arc shape, and
the other of the second clamp portion and the base portion includes a first protrusion and a second protrusion, the first protrusion engaged with the first groove, the second protrusion engaged with the second groove.

5. A carrying vehicle comprising:
a carrying vehicle body including a prime mover and a drive wheel; and
the clamp mechanism recited in claim 1, the clamp mechanism attached to the carrying vehicle body.
